(19) United States
(12) Patent Application Publication
(10) Pub. No.: US 2022/0180281 A1
(43) Pub. Date: Jun. 9, 2022

(54) SYSTEM AND METHOD FOR OPTIMIZING MISSION PLANNING, TASK MANAGEMENT AND ROUTING FOR AUTONOMOUS YARD TRUCKS

(71) Applicant: Outrider Technologies, Inc., Golden, CO (US)

(72) Inventor: Harry Philip Walton, Lafayette, CO (US)

(21) Appl. No.: 17/525,630

(22) Filed: Nov. 12, 2021

Related U.S. Application Data
(60) Provisional application No. 63/112,728, filed on Nov. 12, 2020.

(51) Int. Cl. G06Q 10/06; G06Q 10/04; G06Q 10/08

(52) U.S. Cl. CPC G06Q 10/06316; G06Q 10/047; G06Q 10/083; G06Q 10/06393; G06Q 10/063114

(57) ABSTRACT

This invention provides system and method for optimizing the operation of a shipping facility having trailers that are handled using AV yard trucks. The optimization can be focused on critical time periods where demand for AV yard trucks is high. In non-critical times the AV yard truck(s) can “recover” and “re-stage” within the yard to prepare for future critical times. Unlike human drivers who typically need to remember where to deposit empty trailers for a particular OTR carrier, the zones established with an automated yard system and optimization techniques herein can allow for freer placement of trailers in a manner that best serves the overall schedule of the yard facility. The optimization can be based upon time/overhead costs for differing tasks and determining how to minimize such costs by optimizing assignment of tasks to AV yard trucks on a truck-by-truck basis and in an order that minimizes such costs.

### FIELD OF THE INVENTION

This invention relates to autonomous vehicles, and more particularly to management of tasks, schedules and routes for autonomous vehicles.

### BACKGROUND OF THE INVENTION

Trucks are an essential part of modern commerce. These trucks transport materials and finished goods across the continent within their large interior spaces. Such goods are loaded and unloaded at various facilities that can include manufacturers, ports, distributors, retailers, and end users. Large over-the road (OTR) trucks typically consist of a tractor or cab unit and a separate detachable trailer that is interconnected removably to the cab via a hitching system that consists of a so-called fifth wheel and a kingpin. More particularly, the trailer contains a kingpin along its bottom front and the cab contains a fifth wheel, consisting a pad and a receiving slot for the kingpin. When connected, the kingpin rides in the slot of the fifth wheel in a manner that allows axial pivoting of the trailer with respect to the cab as it traverses curves on the road. The cab provides power (through (e.g.) a generator, pneumatic pressure source, etc.) used to operate both itself and the attached trailer.

A wide range of solutions have been proposed over the years to automate one or more processes of a truck, thereby reducing or eliminating the input labor needed by a driver. In one application, trucks that are used to shunt trailers around a yard between storage/parking locations and loading/unloading docks. Such vehicles are generally termed “yard trucks” and can be powered by fossil fuels or electricity in various configurations. Various novel autonomous vehicle implementations and function associated with autonomous vehicle yard trucks (herein termed “AV yard trucks”), are described in commonly assigned U.S. patent application Ser. No. 16/282,258, entitled SYSTEMS AND METHODS FOR AUTOMATED OPERATION AND HANDLING OF AUTONOMOUS TRUCKS AND TRAILERS HAULED THEREBY, filed Feb. 21, 2019, and related applications thereto, the teachings of which are expressly incorporated herein by reference by way of useful background information.

A significant challenge in managing a fleet of AV yard trucks is to properly manage the timing and order of their operations. One organizational technique related to the facility itself is described in commonly assigned U.S. Provisional Application Ser. No. 63/031,552, entitled SYSTEM AND METHOD FOR OPERATING AND MANAGING AN AUTONOMOUS VEHICLE INTERCHANGE ZONE, filed May 28, 2020, the teachings of which are expressly incorporated herein by reference as useful background information. This application provides a zoned arrangement with respect to a shipping facility that enhances safety and efficiency in the presence of AV yard trucks. However, challenges remain in efficiently managing the AV yard trucks themselves as they carry out tasks in a zoned or unzoned yard environment.

### SUMMARY OF THE INVENTION

This invention overcomes disadvantages of the prior art by providing a system and method for optimizing the operation of a shipping facility having trailers that are handled using AV yard trucks. Notably, the system and method can employ knowledge of trailer location due to a controlled yard and inventory of trailers, which allows for optimization of space and empty trailer locations, and such can be used to improve performance metrics. The optimization can be focused on critical time periods where demand for AV yard trucks is high or peak. Conversely, in non-critical times the AV yard truck(s) can “recover” and “re-stage” within the yard to prepare for future critical times. This also has potential as an optimization model/process. Also, unlike human drivers who must typically need to remember where to deposit empty trailers for a particular OTR carrier, the zones established with an automated yard system and optimization techniques herein can allow for freer placement of trailers in a manner that best serves the overall schedule of the yard facility. The optimization can be based upon time/overhead costs for differing tasks and determining how to minimize such costs by optimizing assignment of tasks to AV yard trucks on a truck-by-truck basis and in a particular order that minimizes such costs.

In an illustrative embodiment, a system and method (and associated AV yard truck responsive thereto) is provided for optimizing movement routing of one or more autonomous vehicle (AV) yard trucks around a shipping facility. The system includes a server that receives location and status information with respect to the one or more AV yard trucks relative to the facility. The server stores information with respect to task locations and types. A scheduling processor determines initial conditions for tasks and that computes scores for most efficiently carrying out of tasks with respect to each of the one or more AV yard trucks. An interface directs an on-board processor for each of the one or more AV yard trucks to carry out the tasks in a specified order. Illustratively, each of the AV yard trucks can provide information based upon a plurality of mounted sensors to the server. The sensors can generate data that is translated into tasks by the server. The data can be stored and used by the scheduling processor. Such data can include AV yard truck missions related to tasks, the identity of available AV yard trucks, and/or performance estimates for AV yard trucks with respect to the tasks and control parameters. The scheduling processor can also assign costs to performance of tasks and optimize based upon costs. The costs can relate to transitions between predetermined tasks.

In another illustrative embodiment, an autonomous vehicle (AV) yard truck is provided. The AV yard truck includes an onboard processor that controls movement and operations of the AV yard truck. The onboard processor is its responsive to sensors mounted on the AV yard truck and it communicates with a server of a shipping facility having a process for optimizing routing of the AV yard truck around a shipping facility. The server receives location and status information with respect to the one or more AV yard trucks relative to the facility and storing information with respect to task locations and types. The onboard processor further includes an interface adapted to exchange data with a remote scheduling processor that determines initial conditions for tasks and that computes scores for most efficient carrying out of tasks with respect to each of the one or more AV yard trucks. The on-board processor thereby directs the AV yard truck to carry out the tasks in a specified order

### BRIEF DESCRIPTION OF THE DRAWINGS

The invention description below refers to the accompanying drawings, of which:

FIG. 1 is a diagram showing an exemplary shipping facility including areas for loading and unloading trailers hauled by OTR trucks, and having a yard management system in the form of one or more servers and communications interfaces that control a plurality of AV yard trucks;

FIG. 2 is a diagram showing an exemplary server architecture for a yard management system of FIG. 1 in communication with on-board processor(s) of an AV yard truck, having an optimization process(or) that enhances operational efficiency of the AV yard trucks as they pickup, haul and drop off trailers, and perform other activities, such as charging, within the facility;

FIG. 3 is a flow diagram showing a procedure for optimizing the operation of AV yard trucks using various stored and input data in conjunction with the optimization process(or) of FIG. 2;

FIG. 4 is a flow diagram of a sub-procedure for delivering mission sequence information from the optimization procedure of FIG. 3 to AV yard trucks;

FIG. 5 is a table of an exemplary set of available AV yard trucks that are assigned tasks based upon a model for computing optimized tasks employed by the optimization process(or) of FIG. 2;

FIG. 6 is a table showing an exemplary list of tasks to be performed by at least one of the AV yard trucks in FIG. 5;

FIG. 7 is a table showing an exemplary tabulation of costs for tasks used by the model in computing optimized missions for the AV yard trucks in FIG. 6;

FIG. 8 is a table showing allowed tasks based upon constraints imposed by the model for each of the AV yard trucks of FIG. 5 and tasks of FIG. 6;

FIG. 9 is a table showing a computation of cost by the model for an exemplary schedule of tasks for one of the AV yard trucks of FIG. 6, showing an non-optimized result; and

FIG. 10 is a table showing a computation of cost by the model for an exemplary schedule of tasks for one of the AV yard trucks of FIG. 6, showing an optimized result.

### DETAILED DESCRIPTION

### I. Overview

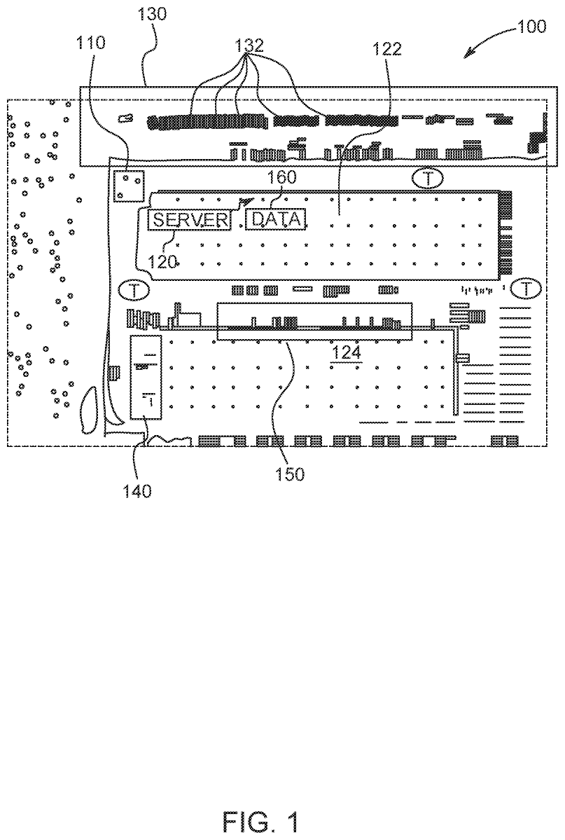

FIG. 1 shows an aerial view of an exemplary shipping facility 100, in which over-the-road (OTR) trucks (tractor trailers) deliver goods-laden trailers from remote locations and retrieve trailers for return to such locations (or elsewhere—such as a storage depot). In a standard operational procedure, the OTR transporter arrives with a trailer at a destination's guard shack (or similar facility entrance checkpoint) 110. The guard/attendant enters the trailer information (trailer number or QR (ID) code scan-imbedded information already in the system, which would typically include: trailer make/model/year/service connection location, etc.) into the facility software system, which is part of a server or other computing system 120, located offsite, or fully or partially within the facility building complex 122 and 124. The complex 122, 124 includes perimeter loading docks (located on one or more sides of the building), associated (typically elevated) cargo portals and doors, and floor storage, all arranged in a manner familiar to those of skill in shipping, logistics, and the like.

By way of a simplified operational example, after arrival of the OTR truck, the guard/attendant would then direct the driver to deliver the trailer to a specific numbered parking space in a designated staging area 130—shown herein as containing a large array of parked, side-by-side trailers 132, arranged as appropriate for the facility's overall layout. The trailer's data and parked status is generally updated in the company's integrated yard management system (YMS), which can reside of the server 120 or elsewhere.

Once the driver has dropped the trailer in the designated parking space of the staging area 130, he/she disconnects the service lines and ensures that connectors are in an accessible position (i.e. if adjustable/sealable). If the trailer is equipped with swing doors, this can also provide an opportunity for the driver to unlatch and clip trailer doors in the open position, if directed by yard personnel to do so.

At some later time, the (i.e. loaded) trailer in the staging area 130 is hitched to a yard truck/tractor, which, in the present application is arranged as an autonomous vehicle (AV). As depicted a plurality of AV yard trucks, each designated with a T, are shown dispersed throughout the facility 100, either halted or in motion to perform a scheduled task. Thus, when the trailer is designated to be unloaded, the AV yard truck is dispatched to its marked parking space in order to retrieve the trailer. As the yard truck backs down to the trailer, it uses one or multiple mounted (e.g. a standard or custom, 2D grayscale or color-pixel, image sensor-based) cameras (and/or other associated (typically 3D/range-determining) sensors, such as GPS receiver(s), radar, LiDAR, stereo vision, time-of-flight cameras, ultrasonic/laser range finders, etc.) to assist in: (i) confirming the identity of the trailer through reading the trailer number or scanning a QR, bar, or other type of coded identifier; (ii) Aligning the truck's connectors with the corresponding trailer receptacles. Such connectors include, but are not limited to, the cab fifth (5th) wheel-to-trailer kingpin, pneumatic lines, and electrical leads. Optionally, during the pull-up and initial alignment period of the AV yard truck to the trailer, the cameras mounted on the yard truck can also be used to perform a trailer inspection, such as checking for damage, confirming tire inflation levels, and verifying other safety criteria.

The hitched trailer is hauled by the AV yard truck to an unloading area 140 of the facility 124. It is backed into a loading bay in this area, and the opened rear is brought into close proximity with the portal and cargo doors of the facility. Manual and automated techniques are then employed to offload the cargo from the trailer for placement within the facility 124. During unloading, the AV yard truck can remain hitched to the trailer or can be unhitched so the yard truck is available to perform other tasks. After unloading, the AV yard truck eventually removes the trailer from the unloading area 140 and either returns it to the staging area 130 or delivers it to a loading area 150 in the facility 124. The trailer, with rear swing (or other type of door(s)) open, is backed into a loading bay and loaded with goods from the facility 124 using manual and/or automated techniques. The AV yard truck can again hitch to, and haul, the loaded trailer back to the staging area 130 from the loading area 150 for eventual pickup by an OTR truck. Appropriate data tracking and management is undertaken at each step in the process using sensors on the AV yard truck and/or other manual or automated data collection devices—for example, terrestrial and/or aerial camera drones.

### II. Optimization of Tasks, Planning and Routing

A. General Considerations

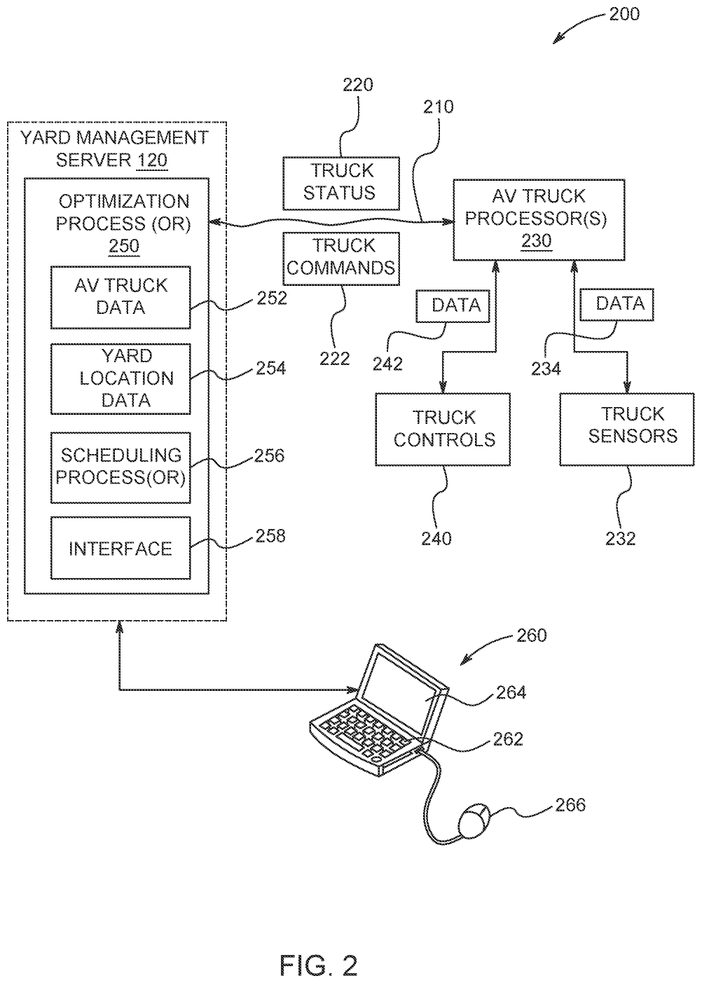

Reference is further made to the control arrangement 200 of FIG. 2. In controlling operations of the facility 100 in managing operation of AV yard trucks (T), the server 120 interacts with processor(s) 230 on each truck using, for example, a wireless link 210 that receives various forms of status information 220 and telemetry (e.g. truck identification, visual, radar, LiDAR and other data 234 from on-board sensors 232 speed and location information, surrounding environmental information, trailer identification information, etc.). Based on status data 220, the server 120 processes delivers commands and control data 222 over the link 210 to the con-board processor(s) 230, to generate part of the control data 242, used to operate the AV truck and its various systems 240.

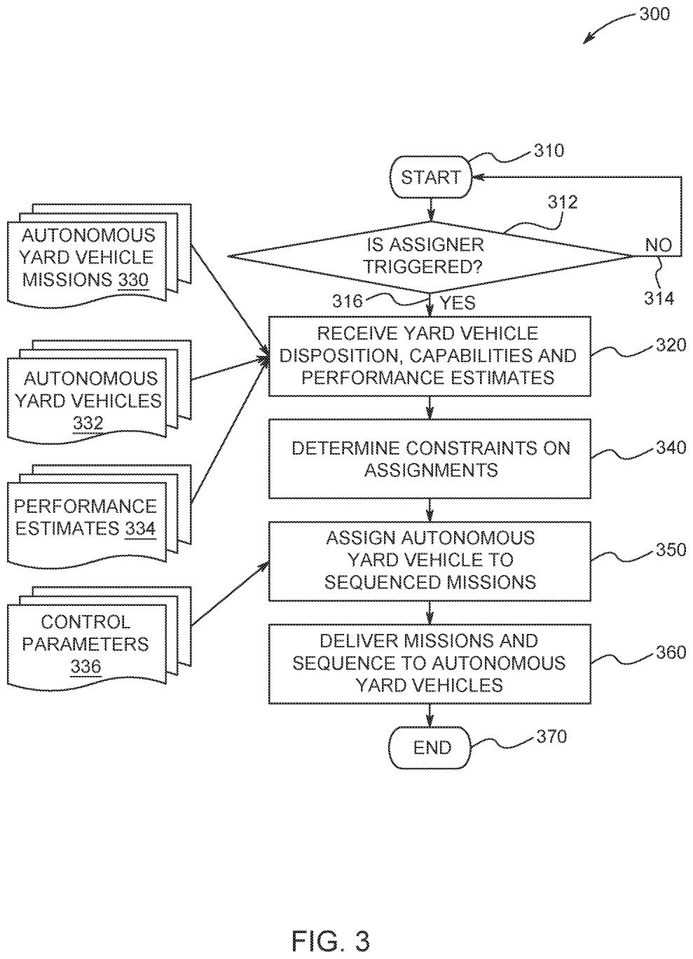

The server 120 includes a variety of processing modules for handling AV yard truck movement, docking, safety, hitching and unhitching of trailers, and other operational functions (not shown). According to an illustrative embodiment, the architecture of the server 120 also includes an optimization process(or) or module 250. This process(or) 250 can contain a variety of processes/ors and/or functional modules to store and handle data in accordance with the illustrative embodiments herein, and described further below. By way of non-limiting example, the optimization process(or) 250 includes storage and handling for data from each of the AV yard trucks 252, and yard location data 254, which can include a layout of the yard, routes, locations of trailers and yard trucks. The process(or) 250 can also include a generalized scheduling process(or) 256 that uses truck and yard location data to perform the optimization functions of the illustrative embodiments herein, as described below (see FIG. 3 below). An interface function translates data between the server, the AV yard trucks and one or more users, who can access and control operations via a linked interface device 260, such as a general purpose PC, laptop, tablet, smartphone, etc. having an appropriate hard or soft keyboard 262 and graphical user interface (GUI, consisting, e.g. of a touchscreen 264 and/or mouse 266). The interface can be enabled to handle data using (e.g.) a web browser application that sends and receives HTML (or another data format) from the server interface 258. Such user interface arrangements can be highly variable in a manner clear to those of skill in the art.

B. Goals of Optimization and Basic Definitions

The optimization processor 250 and associated functions and overall procedure achieve various goals as described below.

1. Routing optimization —the procedure determines over the course of day which AV yard trucks (also termed, simply “AVs”) will service which missions to minimize “extra” or “bobtail” time/distance while maintaining deadlines. This function involves sequencing a queue and assigning AVs to reduce travel/time. Re-planning on a periodic basis is undertaken as appropriate. Spots to place trailers are still dispatcher-selected.

2. Spot selection optimization—The procedure selects the best spots for dropping trailers in the yard based on overall performance metrics that include (a)

generally, spots are driver (or dispatcher) choice for non-autonomous today; (b) dispatchers pick spots today with Mission Control; (c) from an “empty” inventory and full-temporary-storage selection, when a trailer is moving into/out of the yard. Docks, IZ, and OTR endpoints are terminal and specific for specific full trailers.

3. Schedule optimization —this procedure handles a full day of routing and scheduling for AVs and yard operation, and adjusts routing and scheduling as needed throughout the day due to divergence.

4. Empty trailer selection—This procedure is related to spot selection optimization above, and implicates rules that empty trailers are generally selected by the dispatcher using Mission Control for the particular day. The selection takes into account that:

a. a bad empty selection can cause additional distance/time;

b. careful selection of an empty trailer can also gain opportunity for improved spot selection (moving an empty creates a vacant spot); and/or

c. inventory tracking can be a factor.

In general, as used herein, the term “spot” or “spots” relates to places to park trailers within the facility. Note that “missions” (described below) in this environment generally serve to move a trailer from one “spot” to another “spot”. Additional spot definitions include:

“Docks spots” have a special purpose and are generally entry points for freight to enter/exit warehouses.

“OTR/IZ spots” are generally connections where freight enters “the yard” and generally relate to OTR truck activities and the above described interchange zones (IZ) than can exist in the facility.

“Spots” in the facility/yard are where trailers are parked and retrieved by AVs and OTR trucks.

“Special spots” are where support activities can occur, such as recharging fully electric AVs.

C. Task Assignment Routing Flow

The following are further considerations in connection with the system and method and associated optimization operations herein.

1. Exemplary AV Missions

The system and method specifies various tasks/missions to be undertaken by AVs, including the following:

a. normal missions indicating a movement of a trailer from one spot to another—this can also include a completion deadline;

b. repositioning of a trailer within the yard to improve traffic flow—this particular activity may not include a specific deadline; and/or

c. charging of the AV at an appropriate charging location,

(i) charging missions are added as they are needed based on workload and status of the AV,

(ii) charging takes into account mission duration and deadline,

d. move out of the way of traffic and/or timeout,

(i) move/timeout can include evacuating to special staging spots that may or may not also accommodate a trailer, and/or

(ii) Move/timeout can also include special kinds of operations where the vehicle should vacate an area due to contention for space and/or safety considerations.

2. Exemplary AV Operations

AVs have automated mechanisms, sensors and programming that facilitate hitching to, and unhitching from, trailers. AVS are particularly adapted to travel through and around a facility/yard on approved paths while hauling a hitched trailer between particular spots (defined above). AVs are able to navigate in an autonomous fashion based upon onboard sensors/processor(s) and commands from the facility server 120. It is noted that there are certain aspects of AVs which are distinct when combining missions into a routing. That is, AVs have distinct IDs and specialized equipment (sensors/processor(s)) on board. This specialized equipment is related to the AV's perception of the environment and interaction with the physical world. Different equipment may have different performance characteristics which may impact the performance (speed, accuracy, etc.) of the vehicle which may, thus, impact the expected performance. Some relevant information about the AV that is stored in the server (data stores 252, 254), and employed by the scheduling module includes, but is not limited to:

a. AV identification;

b. AV model/software/hardware version; and/or

c. AV performance specification(s), such as

(i) normal speed,

(ii) trailer service line connection robot arm versioning which may impact time performance of service line connections and/or overall hitching,

(iii) sensors and perception, etc. indicating safe operating characteristics, and

(iv) AV power (battery) consumption and current charge state.

3. Exemplary AV Performance Estimates

Historical performance of the AVs is gathered and tabulated as they operate and is used to estimate each unique vehicle's performance for specific activities which comprise specific missions in the facility/yard. These data include:

a. an estimation engine outside of the scope here forms expected behavior per mission regarding time, distance, and power consumption;

b. special operations in these estimates include time and related characteristics for backing up a trailer, hooking up service/air lines, unhitching and dropping the trailer.

4. AV Control Parameters

The system and method of the illustrative embodiments operates based upon certain control parameters, which can include, but are not limited to

a. constants in Task Assignment (heading C above) model;

b. the time horizon for filtering missions and/or future plans;

c. any cost (overhead) trade-offs between being on-time and having an efficient routing with minimal non-productive distance/time incurred;

d. encouragement level for uptaking non-required work; and/or

e. expected consumption rate for power/energy in operating AVs Note that the control parameters can be adjusted as appropriate through other software components by a person monitoring the system to tune behavior. Such can be accomplished via an appropriate user interface (e.g. computing device 260).

D. Routing Flow Procedure

Reference is now made to FIG. 3, shows an exemplary procedure 300 for AV truck routing flow according to an exemplary embodiment, and in conjunction with the definitions and parameters described above. The procedure 300 (block 310) and determines whether an assignment has been triggered (decision step 312). A variety of trigger conditions can occur, including, but not limited to, (1) initialization of the system, (2) creation/removing of missions for the AVs to perform, (3) addition or removal of an AV from the pool of available resources to perform missions; and/or (4) forced assignment of tasks via user intervention with (e.g.) a GUI. According to decision step 312, until a trigger condition is met, the procedure 300 idles (via procedure branch 314) without (free of) performing assignments. However, when a trigger condition is met, the decision step 312 branches (via branch 316) to step 320 in which the procedure receives yard vehicle disposition, capabilities and performance estimates. This procedure step employs input data from AV missions 330 (heading C(1) above), AV operations/identification 332 (heading C(2) above), and performance estimates 334 (heading C(3) above). Operation of step 320 includes any available missions and their capability requirements. Note that not all AVs are considered identical in that one or more AVs may not be adapted to perform some tasks or special vehicles may exist that are adapted to perform certain special tasks. Generally this is considered to be a default assignment or task in that it contains one or more task(s) to perform and a mechanism/process to perform such task(s) to do it.

Having received an assignment and associated parameters therefor, the procedure now determines an order of tasks and the specific tasks required. In step 340, the procedure determines any constraints on the assignment(s). The Task Model below provides further details on forming of the constraints and modeling using mathematical notation. The mathematical expression is provided to a commercially available Mixed Integer Linear Programming (MILP) computer software package/process to provide a solution. Some general (high level) constraints that are solved relate to estimates and limitations on time and distance. Another constraint to be considered is the status of mission as either a must cover or optional task. Constraints can also be based upon deadlines, where keeping them is preferred and penalties are attached if they are surpassed. Likewise surpassing a stated workload can be penalized in the constraint calculation. Outcomes can also be constrained to a contiguous sequence of missions per AV. In addition, power consumption by the AV can be the basis of constraints.

In step 340, some system components are not specifically governed by the mathematical model, below in determining whether, and to what extent, such define constraints on assignments. These non-algorithmic (mathematically-based) constraints can be based upon the following factors:

a. manual intervention is accepted and is formed as constraints on the model—for example, if a dispatcher or operator instructs the system that a particular automated yard vehicle MUST move a specific mission, then this will directly flow into the system rather than be called out explicitly in the model below; and/or

b. stalls or blockages in the yard (such as an OTR driver driving in front of an AV, and thereby, causing an automated safety stop) will coerce a re-plan of an AV—this event can be expressed as several changes in the system at once (removal of mission, addition of mission, new mission forced assignment, etc.), which may or may not implicate the model below.

Note that a primary objective of the model below is minimization of non-productive work and missing deadlines while performing all required missions and encouraging non-required missions to be performed.

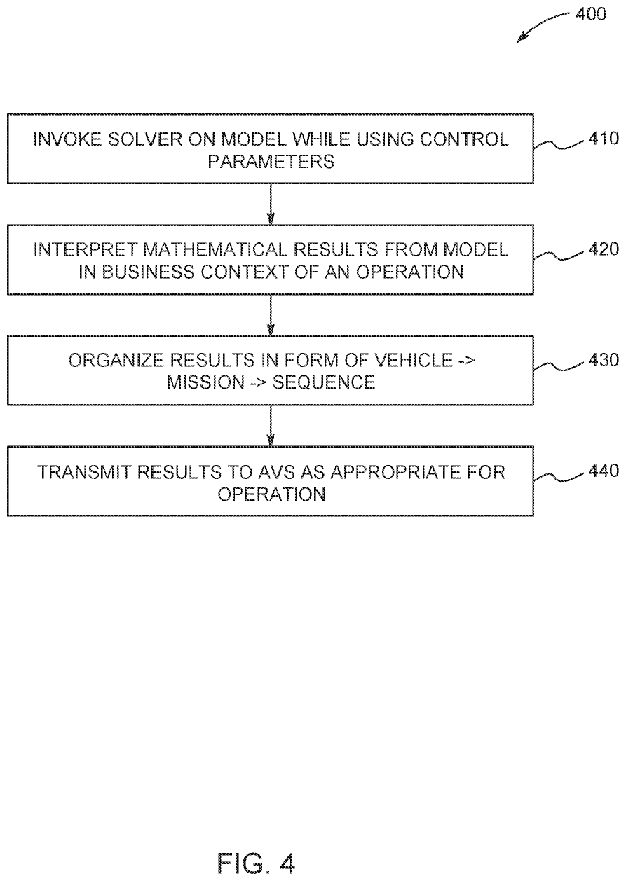

Next, in step 350, the procedure 300 assigns an AV to sequenced missions, taking the control parameters 336 (heading C(4) above) as inputs. The sub-steps of this procedure 400 are depicted in FIG. 4. The procedure 400 includes invoking the solver on the model in conjunction with the use of the control parameters 336 to control the model process and guide its results (step 410). The procedure 400 receives the model's algorithmic/mathematical results and interprets them in the context of the business of handling and operating AVs (step 420). Then in step 430, the interpreted results are then formatted to be useable by the control processes within the server and AV. For example a generalized format of “vehicle->mission->sequence” can be employed. These are delivered to the general procedure 300 in step 440.

Finally, in step 350 of the procedure 300, the formatted results (missions and sequences) from the procedure 400 are then delivered to each identified AV. This allows the results to be acted upon by the various server and on-board controllers as appropriate. The procedure 300 ends (370) until it is again triggered (step 312).

The results of model described below can include (a) the AV mission, (b) sequence of operations, (c) timing estimates for tasks, and (d) task performance expectations.

It is further contemplated that the timing, distance and/or energy estimates herein are later compared to actual results generated by the procedure 300 to improve the generation of performance estimates. This can be accomplished on a feedback loop that operates in parallel to the other runtime operations herein.

### III. Task Model

The purpose of the task model is to form a sequence of tasks which will effectively route tasks over a predetermined planning horizon for an AV. Detailed scheduling can be achieved in a separate model. The task model can define various features, including but not limited, to (a) the initial conditions, which can comprised committed prior work and/or initial position for the AV; (b) the overall duration limit, including bobtail time and normal work time, for the AV—noting that this can be a soft constraint in that it can be violated at a strong penalty cost in the computations; (c) the near-term deadlines-per-task by the AV; (d) whether the AV either has a first sequence assigned (and potentially more sequences) or no assignments; and (d) allowance for optional work (sometimes termed “filler” or “staging” work) which may be unnecessary or otherwise optional, and has no hard deadline but would be useful if done.

A. Model Overview

1. Model Inputs

The model takes, as inputs to its computations, a set of work tasks, a set of AVs (also termed “trucks” in the model variable set), the bobtail time distance incurred when completing one load and starting the other. In addition, inputs can include:

a. initial tasks which the AVs are operating on;

b. duration limit for the AV over the course of the study;

c. duration of each work task;

d. duration of the transitions between each task; and/or e. an indication flag for what work is “optional.”

2. Model Outputs

Based upon the inputs above, and operation of the mathematical/algorithmic processes of the model, the outputs of the model can include:

a. a detailed list (and ordering) for tasks for each AV;

b. details of the transitions used;

c. details of any duration overage; and/or

d. identification of any AVs/trucks with no assignments.

3. Model Targets

The model operates to target reduction of bobtail miles between work tasks. If the work actually done is considered a sunk cost, then this is an advantageous goal. This can allow its use to engage additional work, such as staging empty trailers without (free-of) considering moving them to be considered a “cost” or overhead in the computation. In this context, only the bobtail is considered “cost” in the computation. A consideration is that staging trailers, in certain cases, can reduce bobtail travel and be considered “almost free work”.

4. Modeling Assumption

As a caveat, the illustrative embodiment of the model does not take into consideration of any special tasks for the AV such as recharging, or (when provided) an AV safety-driver on break (e.g. at-lunch).

5. Model Details

The model includes the following Index Sets:
TRUCKS≡Available Outrider AVs
WORK≡some activity required during the course of the time horizon
SEQUENCE≡sequence in which work is done {0≤s≤sizew}

The model includes the following Model Data:
bobtail_{wx}≡distance between end of work w and start of work x
sizew≡|W|≡total number of work elements
initialLoad_{tw} ≡initial load is set to 1 for each truck, 0 ow
   Note that if initialLoad values are all set to one for a truck then the truck has no initial condition. Think of a 1 as “this is an optional first load”

δ≡Max percent of work count given to trucks (maybe 1+ceil(|WORK|/|TRUCKS|)+0.2?)?)

durationLimitₜ≡Max duration (loaded and transition durations added) allowable for a truck.
bobtailDuration_{wx}≡Estimated duration of the bobtail between work w and work x
workDuration_{w} ≡Estimated duration of performing work w
PenO ≡Penalty for each time unit over the limit.
deadLine_{w}≡Duration from epoch when work should be completed by or before (soft but high penalty)
PenD ≡Penalty per blown deadline time unit
PenN ≡Penalty (marginal) for NOT using a truck at all

M≡Some big number in this case recommend 2*|HORIZON|

optionalWork_{w} ≡1 ⇔this particular work is optional, 0 otherwise
optionalBonus_{w} ≡Since optional will need to overtake the bobtail_{wx} cost

The model includes the following variables:

C_{tws}≡truck t covers work w at sequence s: C_{tws}ϵ{0,1}

T_{wxt} ≡transition by truck t between work w and x is required: T_{wxt} ϵ{0,1}
Oₜ ≡amount over duration for truck t
D_{w} ≡blown deadline unit of time
Eₜₛ ≡elapsed bobtail time from this sequence's transition from prior sequence
Nₜ ≡No assignments for truck t

The objective of model computations is to minimize sum of bobtail distance along with bonuses for “good” behavior and penalties for undesirable behavior. The following relationship applies:

minimize Σ_{tοTRUCKwϵWORK,xϵWORK\w} bobtail_{wx}T_{wxt}+Σ_{tϵTRUCK} PenO*Oₜ Σ_{wϵWORK} PenD*D_{w}+Σ_{tϵTRUCK} PenN*Nₜ−Σ_{tϵTRUCK,wϵWORK,sϵSEQUENCE} optionWork_{w}*optionalBonus_{w}

where the relationship is subject to the following constraints:
Track sequence starts at the first or is not used (N is set)

$${N}_{t} + {\sum }_{w ∈ WORK} {initialLoad}_{tw} {C}_{tws} = ∀ t ∈ TRUCKS , s ∈ SEQUENCE : s == 0$$

Based upon the model, if a truck isn't used in the first sequence then it is never used and the following applies:

Σ_{wϵWork,sϵSEQUENCE}C_{tws}+Nₜ≤1∀tϵTRUCKS

Every truck sequence can be used at most once (sequence) as provided below:

$${\sum }_{w ∈ W O R K} {C}_{t w s} \leq 1 ∀ t ∈ TRUCKS , s ∈ SEQUENCE$$

Additionally, every (sequence >0) must have a prior sequence set (contiguous), thereby providing the following:

$${\sum }_{x ∈ W O R K ∖ w} {C}_{t x s} \leq {\sum }_{w ∈ W O R K} {C}_{t w s - 1} ∀ t ∈ TRUCKS , s ∈ SEQUENCE : s > 0$$

Hence, the foregoing relationships yield a final form for the relationship used by the model:

$${\sum }_{x ∈ W O R K ∖ w} {C}_{t x s} - {\sum }_{w ∈ W O R K} {C}_{t w s - 1} \leq 0 ∀ t ∈ TRUCKS , s ∈ SEQUENCE : s > 0$$

Which, when coercing T-vars to 1 (when appropriate) yields:

T_{wxt}−C_{tws}+C_{tws+1}≥−1∀wϵWORK,xϵWORK\w,tϵTRUCK,sϵSEQUENCE

The model allows setting of E variables, in which Eₜₛ are coerced to have the transition elapsed time leading to this sequence for the associated truck. The following relationship applies:

Eₜₛ≥bobtailDuration_{wx}(C_{tws}+Cₜₓ₍ₛ₋₁₎+T_{wxt}−2)∀wϵWORK,xϵWORK\w,tϵTRUCK,sϵSEQUENCE: s>0

The above constraint provides bottom support for E. The existence of a positive value for ≡entails “costs” in the model algorithm, so an operational/computational objective is to reduce this value. Hence, to accomplish this the following conditions apply:

a. E (Eₜₛ=elapsed bobtail time from this sequence's transition from prior sequence) is assumed to be ≥0;

b. transitions are keyed on loads, not based upon a sequence (T variables/T vars) (i.e. T_{wxt}=transition by truck t between work w and x is required: T_{wxt} ϵ{0, 1});

c. C vars (i.e. Ctws=truck t covers work w at sequence s: Ctwsϵ{0, 1}) are used to provide sequence specific consequences (per d-f, directly below);

d. if no C vars values are positive, then the RHS is “bobtailDuration” negative, which indicates no support, so E=0;

e. if one (1) C var is positive, then the RHS is zero (0) (already minimized for Eₜₛ), which indicates no support so E=0;

f. if both C vars are positive (and T, because the C vars drive the T var) then RHS is bobtailDuration. Reorganizing the equation terms yields the following in a final form:

Eₜₛ−bobtailDuration_{wx}(C_{tws}+Cₜₓ₍ₛ₊₁₎+T_{wxts})≥−2*bobtailDuration_{wx}

∀w ϵWORK, xϵWORK\w, tϵTRUCKsϵSEQUENCE: s>0

Then, with all work assigned (covered), the following applies:

$${\sum }_{t ∈ T R UCK , s ∈ S E Q U E N C E} {C}_{t w s} \geq ( 1 - optionalWor {k}_{w} ) ∀ w ∈ WORK$$

and the tasks are at most covered once

$${\sum }_{t ∈ TRUCK , s ∈ SE Q U E N C E} {C}_{t w s} \leq 1 ∀ w ∈ WORK$$

The model limits overall work and bobtail duration based upon the following:

$${\sum }_{w ∈ WORK , , ∈ SEQU E N C E} w o r k D u r a t i o {n}_{w} * {C}_{t w s} + {\sum }_{w ∈ WORK , x ∈ WOR K ∖ w} b o b t a i l D u r a t i o {n}_{w x} * {T}_{w x t} - {O}_{t} \leq d u r a t i o n L i m i {t}_{t} ∀ t ∈ TRUCK$$

The model can set deadline overages assuming that such is established as a hard constraint that can be effectively non-linear. The overage (D_{w}) term subtracted from workDuration_{w} results in a condition in which the overage affords the system more time to complete a task (at a penalty in the objective). Hence, if C_{tws}==0 the sum of a zero is less than the deadline. However, if the value equals one (1) then the condition actually takes effect.

C_{tws}*((Σ_{xϵWORK\w,rϵSEQUENCE:r<s}workDurationₓ*Cₜₓᵣ)+(workDuration_{w}−D_{w}))<=deadline_{w}∀tϵTRUCK,sϵSEQUENCE,wϵWORK

Divide the above by C_{tws} and the sum of the prior durations (r<s)+duration of this task (minus overage)+transitions<=deadline (and residual data). The following relationship is derived:

Σ_{xϵWORK\w,rϵSEQUENCE:r<s} workDurationₓ*Cₜₓᵣ+Σ_{rϵSEQUENCE:r<s}Eₜᵣ+workDuration_{w}−D_{w}≤deadline_{w}*1/C_{tws}∀tϵTRUCK,sϵSEQUENCE,wϵWORK

Note that the expression of RHS, since its zero-one yields an infinite value if C=0, and a deadline if C=1. The model can select a larger value for M than the entire horizon's duration—for example, 2*|Horizon|. The following relationship thereby applies:

$${\sum }_{x ∈ W O R K ∖ w , r ∈ S E Q U E N C E : r < s} w o r k D u r a t i o {n}_{x} * {C}_{t x r} + {\sum }_{r ∈ S E Q U E N C E : r < s} {E}_{t r} + w o r k D u r a t i o {n}_{w} - {D}_{w} \leq M ( 1 - {C}_{t w s} ) + d eadlin {e}_{w} ∀ t ∈ T R U CK , s ∈ SE Q U E N CE , w ∈ WOR K$$

The final expressions are derived as follows:

LHS: workDuration_{w} is constant, and thus RHS is computed as:

M(1−C_{tws})+deadline_{w}

(M−M*C_{tws})+deadline_{w}

The Second M*C term contains a variable, and thus, the final form of the expression is:

Σ_{xϵWORK\w,rϵSEQUENCE:r<s}workDurationₓ*Cₜₓᵣ+Σ_{rϵSEQUENCE:r<s}Eₜᵣ−D_{w}M*C_{tws}≤M+deadline_{w}−workDuration_{w}∀tϵTRUCK,sϵSEQUENCE,wϵWORK.

### IV. Example of Model in Operation

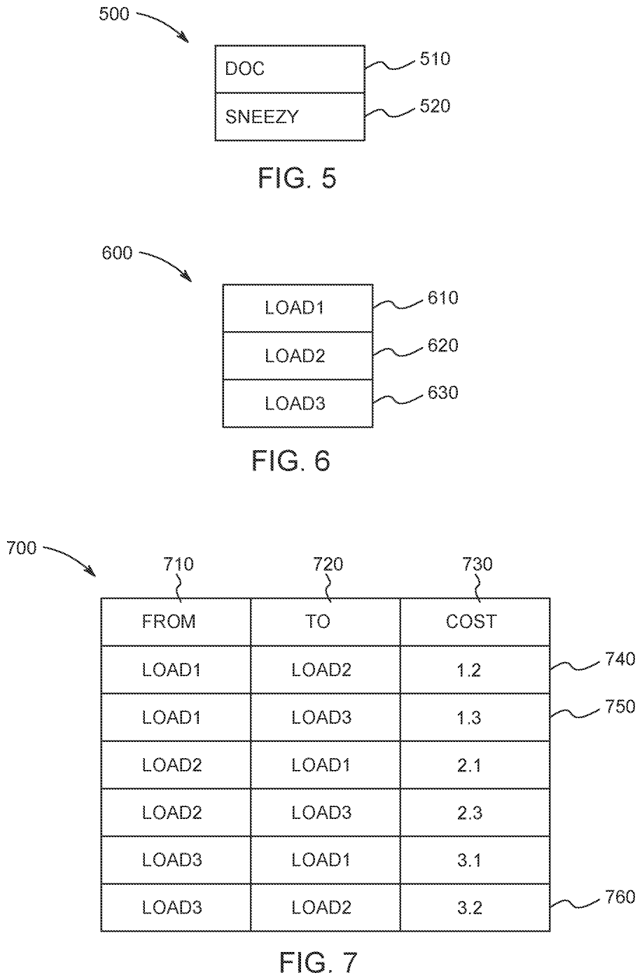

The following is a description of an exemplary optimization procedure carried out using the above-described model. With reference to FIG. 5, a table 500 containing two exemplary entries 510, 520 of AVs (trucks) having associated identifiers or names (e.g. “doc” and “sneezy”) are provided for AVs that are available to perform work. The exemplary work (e.g. Load1, Load2 and Load) is listed as entries 610, 620 and 630 in the table 600. These work tasks will be assigned to available AVs doc and sneezy.

Table 700 (FIG. 7) shows the exemplary transition cost (column 730) from (column 710) leaving one completed task and to (column 720) starting the next for an AV for each transition between loads. That is, the transition from Load1 to Load2 is computed to cost 1.2 (row 740). Likewise, the transition from Load1 to Load3 costs 1.3 row 750). The most expensive transition cost in this example is from Load3 to Load2 (bottommost row 760) at 3.2.

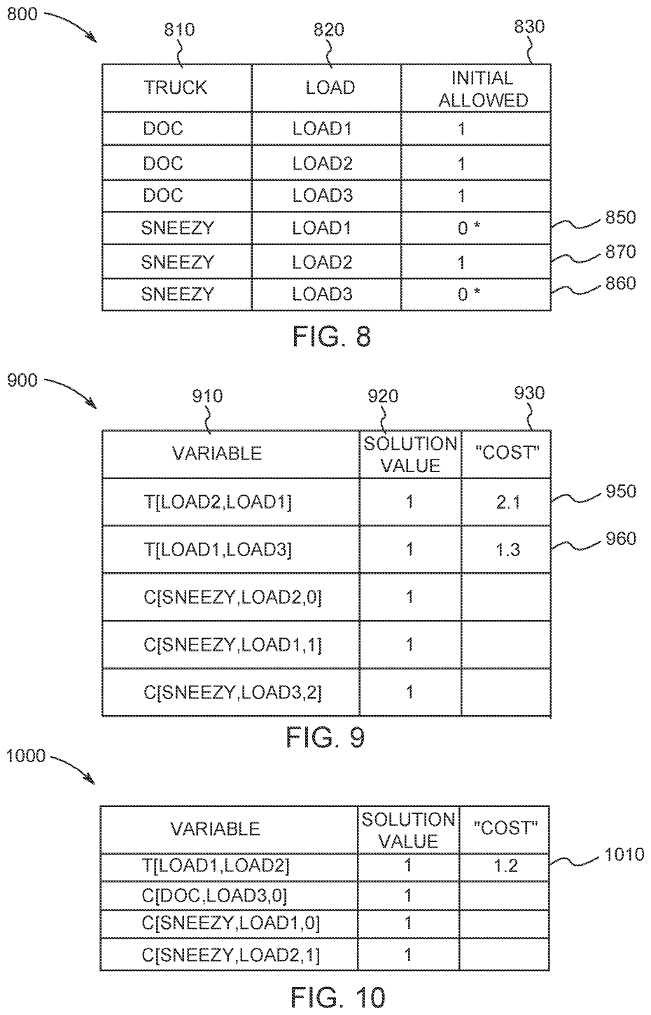

Table 800 (FIG. 8) shows initial conditions (column 830) for each truck (column 810 and load (column 820). Note that a value of 1 (in column 830) indicates such truck/load combination is initially allowed by the system, while a value of 0 forbids the combination. Note that AV sneezy is forbidden from initially carrying out Load1 (row 850) and Load2 (row 860), with both tables rows having value 0, and can initially carry only Load2 (row 870 and value 1). Hence, in the example of AV sneezy→Load 2 is the initial condition.

Table 900 in FIG. 9 shows a solution-finding operation. In a basic example, one solution is to assign all work in order to sneezy in the order: Load2->Load1->Load3. In this example, the variables T and C are provided in column 910, each with a solution value (column 920). The cost is provided in column 930. Based upon the above-described computations, using the model, the proposed solution will incur two (2) transition costs (Load1->Load2 and Load2->load3) (see rows 950 and 960) which yields a total cost (adding values in column 910) of 2.1+1.3=3.4.

Conversely, in the example of table 1000 (FIG. 10), an optimal solution can be provided by the model (absent required initial conditions). In this case, the cost is one transition from Load1 to Load2 in row 1010, and a total associated cost of 1.2, which is the optimized solution value in this example.

### V. Conclusion

It should be clear that the above-described system and method for optimizing the operation of AV yard trucks in a yard/facility that handles trailers provides an effective technique for ensuring efficiency in a variety of different task types. The system and method can be modified as needed by a user to adapt to special circumstances and can include various algorithms that incorporate ongoing feedback to make operation more efficient over time.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, the term “visible” or “visual” in the context of camera sensors should be taken broadly to include non-visible wavelengths, such as ultraviolet (UV) and infrared (IR) likewise, the cameras can include integrated or separate illumination assemblies capable of night-vision, where appropriate. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Also, qualifying terms such as “substantially” and “approximately” are contemplated to allow for a reasonable variation from a stated measurement or value can be employed in a manner that the element remains functional as contemplated herein—for example, 1-5 percent variation. Accordingly, this description is meant to be taken only by way of example, and not to otherwise limit the scope of this invention.

What is claimed is:

1. A system for optimizing routing of one or more autonomous vehicle (AV) yard trucks around a shipping facility comprising:
a server that receives location and status information with respect to the one or more AV yard trucks relative to the facility and that stores information with respect to task locations and types;
a scheduling processor that determines initial conditions for tasks and that computes scores for most efficient carrying out of tasks with respect to each of the one or more AV yard trucks; and
an interface that directs an on-board processor for each of the one or more AV yard trucks to carry out the tasks in a specified order.

2. The system as set forth in claim 1 wherein each of the AV yard trucks provides information based upon a plurality of sensors to the server.

3. The system as set forth in claim 2 wherein the sensors generate data that is translated into tasks by the server.

4. The system as set forth in claim 3 wherein data stored and used by the scheduling processor includes AV yard truck missions related to tasks, the identity of available AV yard trucks, performance estimates for AV yard trucks with respect to the tasks and control parameters.

5. The system as set forth in claim 4 wherein the scheduling processor assigns costs to performance of tasks and optimizes based upon costs.

6. The system as set forth in claim 5 wherein the costs relate to transitions between predetermined tasks.

7. A method for optimizing routing of one or more autonomous vehicle (AV) yard trucks around a shipping facility comprising the steps of:
receiving location and status information with respect to the one or more AV yard trucks relative to the facility and storing information with respect to task locations and types;
determining initial conditions for tasks and that computes scores for most efficient carrying out of tasks with respect to each of the one or more AV yard trucks; and
directing an on-board processor for each of the one or more AV yard trucks to carry out the tasks in a specified order.

8. The method as set forth in claim 7 wherein each of the AV yard trucks provides information based upon a plurality of sensors.

9. The method as set forth in claim 8, further comprising, translating data from the sensors into a plurality of tasks used by the steps of determining and directing.

10. The method as set forth in claim 9 the step of determining includes generating data relative to AV yard truck missions related to the tasks, the identity of available AV yard trucks, performance estimates for AV yard trucks with respect to the tasks and control parameters.

11. The method as set forth in claim 10 wherein the step of determining includes assigning costs to performance of tasks and optimizes based upon costs.

12. The method as set forth in claim 11 wherein the costs relate to transitions between predetermined tasks.

13. An autonomous vehicle (AV) yard truck comprising:
an onboard processor that controls movement and operations of the AV yard truck, responsive to sensors mounted on the AV yard truck and communicating with a server of the shipping facility having a process for optimizing routing of the AV yard truck around a shipping facility, the server receiving location and status information with respect to the one or more AV yard trucks relative to the facility and storing information with respect to task locations and types, the onboard processor including an interface adapted to exchange data with a remote scheduling processor that determines initial conditions for tasks and that computes scores for most efficient carrying out of tasks with respect to each of the one or more AV yard trucks, the on-board processor thereby directing the AV yard truck to carry out the tasks in a specified order.
